(19) United States
(12) Patent Application Publication
(10) Pub. No.: US 2001/0004924 A1
(43) Pub. Date: Jun. 28, 2001

(54) Tire noise reducing system

(76) Inventors: Chieko Aoki, Kobe-shi (JP); Kazuhiko Kawamura, Kobe-shi (JP)

Correspondence Address: BIRCH, STEWART, KOLASCH & BIRCH, LLP, P.O. Box 747, Falls Church, VA, 22040-0747, US

(21) Appl. No.: 09/742,080

(22) Filed: Dec. 22, 2000

(30) Foreign Application Priority Data
Dec. 22, 1999 (JP) 11-365466

(51) Int. Cl. B60C 9/00

(52) U.S. Cl. 156/394.1

(57) ABSTRACT

A tire noise reducing system comprises a wheel rim, a pneumatic tire to be mounted on the wheel rim to form an annular tire hollow, and a noise damper to be disposed in the annular tire hollow, wherein the noise damper is a liquid under use conditions, and the noise damper has a certain volume being capable of changing the cross sectional area of the annular tire hollow irregularly in the circumferential direction during rotating, whereby the mode, amplitude and frequency of resonance of the tire hollow are changed irregularly to damp the resonance. The tire noise reducing system may comprises an apparatus for injecting the foamable liquid damper into the tire hollow, which apparatus comprises a container for the foamable liquid damper, a high-pressure gas source to let the foamable liquid damper from the container, and a nozzle for discharging a mixture of the liquid damper and high-pressure gas foam to be injected into the tire hollow.

### FIELD OF THE INVENTION

The present invention relates to a tire noise reducing system, more particularly to a liquid noise damper for a pneumatic tire and an apparatus for injecting the liquid noise damper into the pneumatic tire.

### DESCRIPTION OF THE RELATED ART

In recent years, as the mechanical noise from automobiles especially passenger cars is greatly reduced, the tires especially passenger car tires are strongly required to reduce their noise. There are many factors in the tire noise, but a circumferential resonance of the air in the annular tire hollow is a major factor. That is, a ring of air inside the tire continuous around the rim is excited by vibrations during running and resonates in the circumferential direction. Usually, a resonance peak occurs in a frequency range of from 50 to 400 Hz according to the tire size.

In the published Japanese patent JP-B-7-14682, an assembly of a wheel rim and a pneumatic tire mounted thereon is disclosed, wherein a ball-like body which is made of rubber, sponge or the like is put in the annular tire hollow to block the circumferential continuity thereof to control resonance.

In case of such a ball-like body, however, if the tire is already in use or mounted on a rim, at least the tire must be demounted from the rim in order to set in the tire hollow. Further, as the ball-like body is solid matter, it has a tendency to make it difficult to mount the tire on a wheel rim.

### SUMMARY OF THE INVENTION

It is therefore, an object of the present invention to provide a tire noise reducing system in which a noise damper for controlling air resonance in the tire hollow can be put in the tire hollow, without demounting the tire, through for example a tire valve, a gap intentionally formed by deflating the tire, or the like.

According to the present invention, a tire noise reducing system comprises a wheel rim, a pneumatic tire to be mounted on the wheel rim to form an annular tire hollow, and a noise damper to be disposed in the annular tire hollow, wherein the noise damper is a liquid under use conditions, and the noise damper has a certain volume being capable of blocking the annular tire hollow.

Therefore, the cross sectional area of the annular tire hollow is irregularly changed in the circumferential direction or the blocked part irregularly changes during running because the damper is a liquid. As a result, if a resonance is caused, the resonance mode, amplitude and frequency are also changed irregularly, and it is effectively damped.

### BRIEF DESCRIPTION OF THE DRAWINGS

FIG. 1 is a cross sectional view of a pneumatic tire.

FIF. 2 is cross sectional view showing a liquid damper which is injected into a tire hollow and partially blocks the tire hollow.

FIG. 3 is cross sectional view showing a liquid damper which is injected into a tire hollow and fully blocks the tire hollow.

FIG. 4 shows a behavior of a damper in a rolling tire.

FIG. 5 shows a foamed damper.

FIGS. 6, 7 and 8 are schematic views each showing an apparatus for injecting the liquid damper.

FIGS. 11-13 are graphs showing vibration transfer functions of a tire when various liquid dampers were injected.

FIG. 14 is a diagram for explaining an impact hammer test.

### DESCRIPTION OF THE PREFERRED EMBODIMENTS

Embodiments of the present invention will now be described in detail in conjunction with the accompanying drawings.

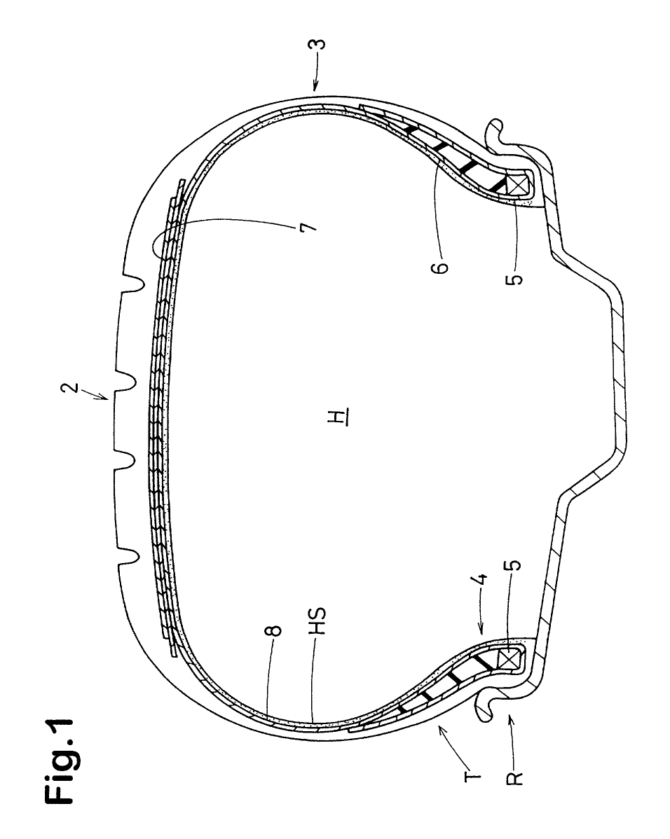

As shown in FIG. 1, a pneumatic tire T comprises a tread portion 2, a pair of sidewall portions 3 and a pair of bead portions 4, and it has a toroidal shape. I general, a bead core 5 or bead wire is disposed in each bead portion 4, and a carcass 6 extends between the bead portions 4 and turned up around the bead cores, and a belt 7 is disposed radially outside the carcass 6 in the tread portion 2.

A wheel rim R comprises a pair of bead seats for the bead portions 4, a pair of flanges extending radially outwardly from the respective bead seats, and a rim well between the bead seats. As the tire T is a tubeless tire, the inner surface HS thereof is covered with an inner liner 8 made of gas impermeable rubber. The tire T is mounted on the wheel rim R and thereby a closed annular tire hollow H is formed between the tire and rim.

According to the present invention, a liquid noise damper 1 is injected into the tire hollow H. As the damper is liquid, it is possible to inject through the tire valve in such a state that the tire T is mounted on the rim R but not fully inflated.

For the liquid noise damper, various liquids can be used as far as the tire materials such as rubbers, cords, wires etc. and those of the wheel rim do not erode.

Liquid noise damper 1

For example, water can be used in mild or warm regions. Even in cold regions, by adding antifreeze, water may be used.

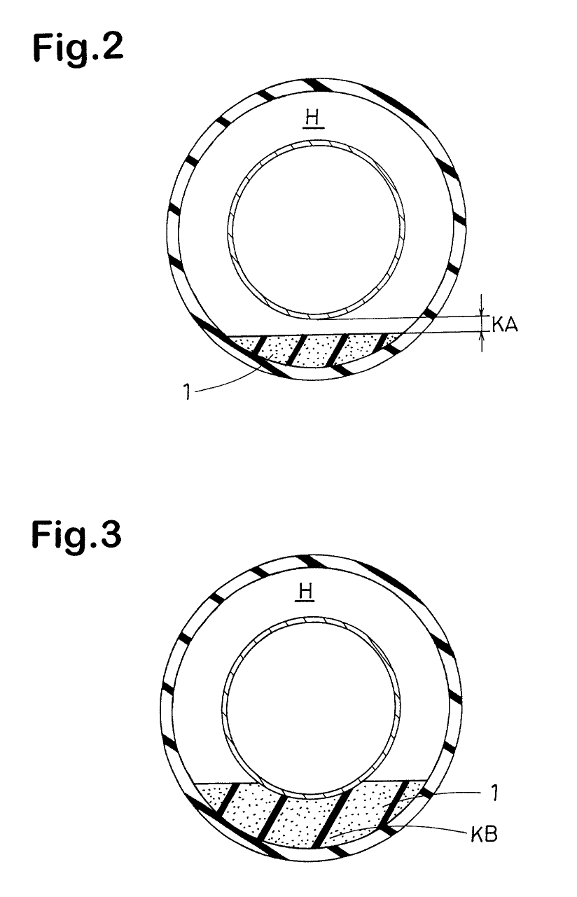

In case of a liquid having a low viscosity such as water, the liquid damper 1 stands in the lower part of the tire hollow H. Thus, according to the injected volume, the tire hollow H is partially or fully blocked as shown in FIGS. 2 and 3. In FIG. 2, the tire hollow H is blocked partially, and a narrow part KA is formed. In FIG. 3, the tire hollow H is fully blocked, and a closed part KB is formed.

In case of low viscosity, the volume of the liquid damper to be injected is preferably more than 0.60 times the volume V0 of the tire hollow H.

Liquid noise damper 2 (Emulsion)

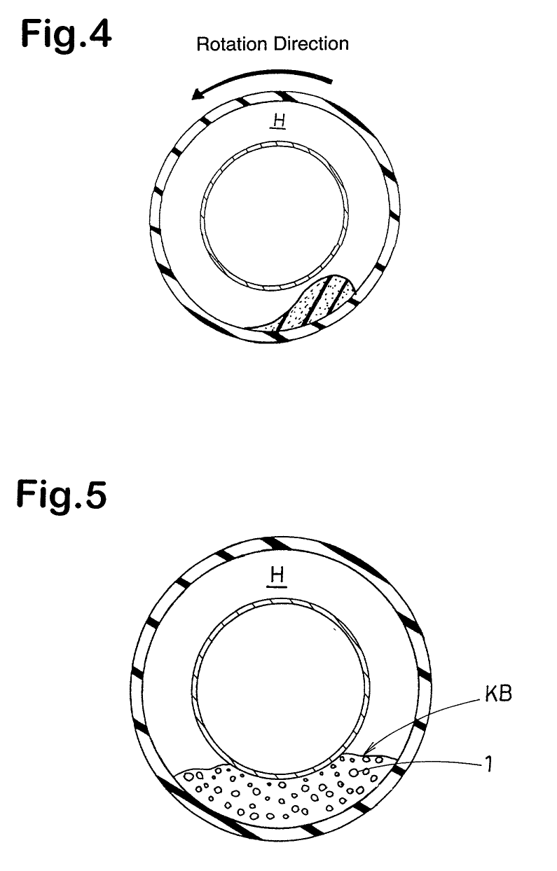

In case of a liquid having a viscosity slightly higher than water, the damper 1 is lopsided towards the rotational direction and rises as shown in FIG. 4. Thus, a narrow part KA or closed part KB can be formed with a less injection volume.

Such a higher viscosity damper 1 may damp not only the vibrations of air in the tire hollow (resonance) but also vibrations of the tread portion 2.

For example, an emulsion of a polymer or polymers can be used. For the polymers, elastomers such as NBR, SBR, BR, NR, IR etc. and synthetic resins such as alkyd resin, polyurethane resin, epoxy resin etc. can be used.

Especially, an emulsion of an elastomer or elastomers, namely, rubber latex is preferably used.

The total solid of the emulsion is preferably set in a range of from 25 to 90, more preferably 40 to 80 parts by weight with respect to 100 parts by weight the emulsion, whereby the injection volume V can be decreased in a range of 0.005 to 0.6 times the volume V0 of the tire hollow H.

If the total solid is less than 25 parts by weight, it is difficult to decrease the injected volume. If more than 90 parts by weight, the fluidity is lost.

Liquid noise damper 3 (Foamy solution)

Further, it is also possible to use a foamy solution which can foam when stirred in the tire hollow by rotations of the tire.

The foam filling the tire hollow can interrupt transmission of vibrations of the tread portion 2 to the air in the tire hollow. Further, the foam can absorb the vibrations of the air in the tire hollow. Therefore, the noise can be effectively reduced.

A water solution of at least one kind of surfactant can be used as the foamy solution.

Preferably, a surfactant which comprises a hydrophobic group of a long straight chain and a hydrophilic group which is not so large and positioned at the end of the hydrophobic group and thus which easily foams, is used. For example, one or more kinds of anionic surfactants, e.g. carboxylic acid type, sulfonic acid type, sulfuric ester type, and phosphate ester type surfactants and the like are used. Besides such anionic surfactants, nonionic surfactants and amphoteric surfactants and further chemicals other than surfactants may be used as far as they easily foam when stirred during rotating.

Preferably, a foam stabilizer is added into the water base foamy solution. For example, proteins such as amides, hydroxylammonium, amine oxide, fatty acid polyhydric alcohol ester, albumin etc., hydrophilic macromolecular substances and the like can be used as the foam stabilizer.

In addition, rubber latex, namely, liquid unvulcanized rubber foam such as silicone foam, polyurethane foam, chloroprene foam, fluorocarbon rubber foam, phenolic foam can be suitably used as the foamy solution.

These materials may foam alone when stirred during rotating. But, it is preferable to foam the rubber latex first using a foaming agent or the under-mentioned apparatus because the duration of the foam is relatively long. In these cases, the injection volume V1 can be set in a range of 0.001 to 0.6 times the volume V0 of the tire hollow H. Preferably, the rate V2/V1 of the foamed volume V2 to the unfoamed volume V1 of the foamy solution is in a range of from 1.5 to 500.

Apparatuses for injecting liquid damper

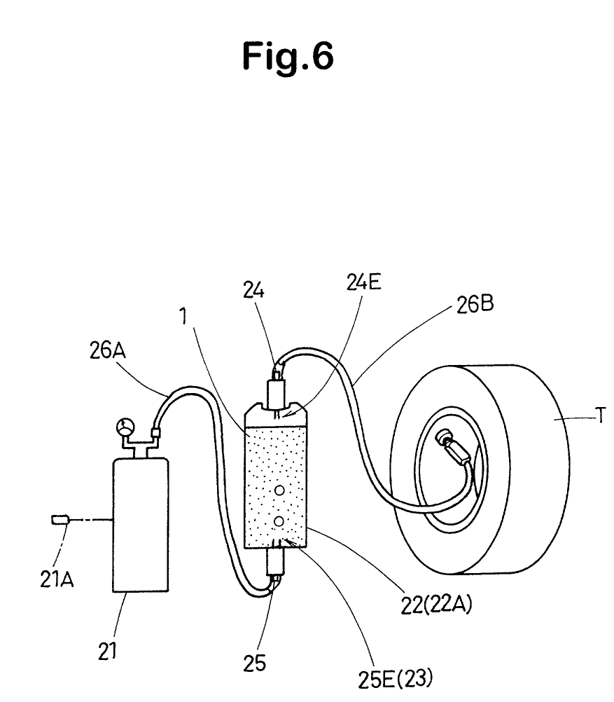

FIGS. 6 to 8 each show an apparatus 20 which can inject the liquid damper 1 into the tire hollow H while foaming the liquid damper. Thus, the apparatus 20 is suitably used with the above-mentioned foamy solution.

The apparatus 20 comprises a container 22 which can hold the foamy solution in an unfoamed state, a high-pressure gas source 21, means 23 of foaming the foamy solution, and a nozzle 24 for discharging the foamed foamy solution and high-pressure gas.

First example of the injecting apparatus

FIG. 6 shows a first example of the apparatus 20.

The high-pressure gas source 21 is an air-compressor which can supplies high-pressure air of 100 to 2000 kpa to the container 22. In this example, a small-sized air-compressor operatable with a car battery is used. Thus, it has a plug 21A to be connected to a DC outlet for a cigarette lighter.

The container 22 has a gas inlet 25 for the high-pressure gas from the high-pressure gas source 21. The gas inlet 25 has an inner end 25E set in the lower portion of the inside 22A of the container 22 so as to open in the foamy solution, and an outer end connected to the air-compressor by a detachable hose 26A. In the upper portion of the container 22, the discharging nozzle 24 is provided. The discharging nozzle 24 has an inner end 24E opened in the inside 22A of the container 22 above the liquid level of the foamy solution. And the discharging nozzle 24 is connected to the tire valve by a detachable hose 26B.

Therefore, when a high-pressure air from the high-pressure gas source 21 gushes out from the inner end 25E of the gas inlet 25, the foamy solution is foamed and led into the tire T together with the high-pressure air through the discharging nozzle 24 and hose 26B.

Second example of the injecting apparatus

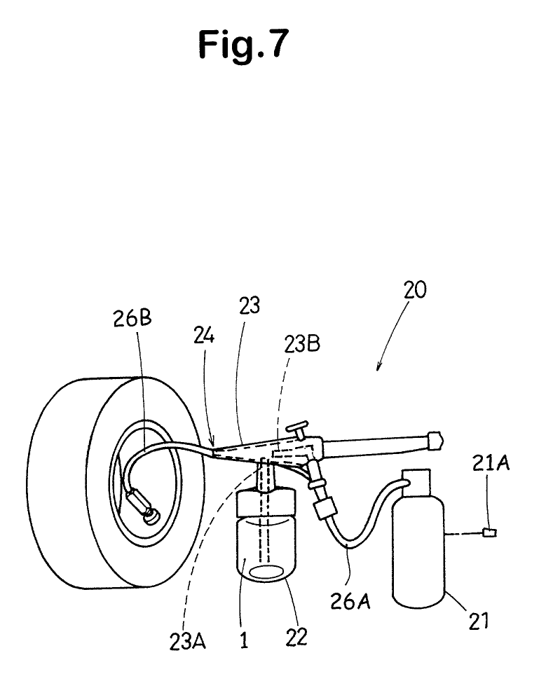

FIG. 7 shows a second example of the apparatus 20.

In this example, the above-mentioned air-compressor is again used as the high-pressure gas source 21. The foaming means 23 in this example is a spray chamber. The discharging nozzle 24 is formed at one end of the spray chamber 23. In the spray chamber 23, a gas nozzle 23B and a spray nozzle 23A are disposed. The gas nozzle 23B is opened towards the discharging nozzle 24. The spray nozzle 23A is opened at a position between the discharging nozzle 24 and gas nozzle 23B substantially on a straight line drawn between the discharging nozzle 24 and gas nozzle 23B. The opening direction is between a direction substantially at a right angle to the straight line and a direction toward the discharging nozzle 24. The container 22 is a bottle of which upper portion is screwed onto the spray chamber 23. A solution passageway or flexible tube extends from the spray nozzle 23A to the bottom of the inside 22A of the container 22. Further, a gas passageway extends from the gas nozzle 23B to the high-pressure gas source 21. The gas passageway includes a pipe set in the spray chamber 23 and a flexible hose 26A extending from the spray chamber 23 to the high-pressure gas source 21.

Therefore, the gas nozzle 23B blows the high-pressure air against the spray nozzle 23A, and accordingly the foamy solution spays from the spray nozzle 23A. The solution is foamed and mixed with the high-pressure air, and they are led into the tire hollow H through the discharging nozzle 24, hose 26B and tire valve.

Third example of the injecting apparatus

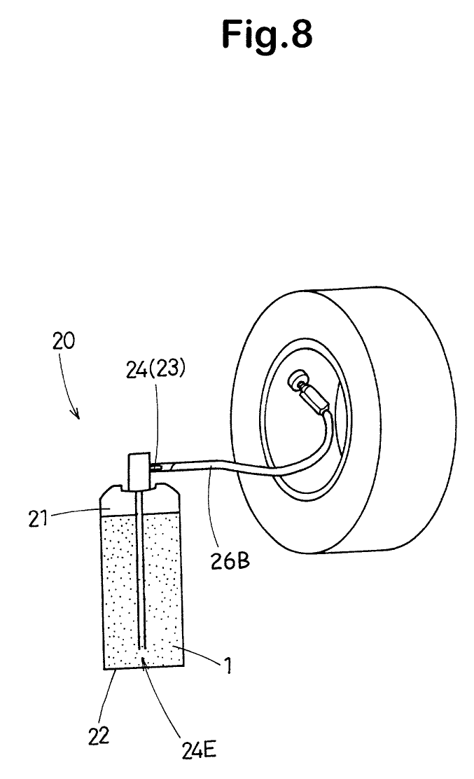

FIG. 8 shows a third example of the apparatus 20.

In this example, the apparatus 20 is an aerosol can type. The inside of an aerosol can 22 is filled with the foamy solution together with liquefied gas, e.g. propane, butane, chloro hydrocarbon fluoride and the like. The discharging nozzle 24 is provided at the upper end of the aerosol can. From the discharging nozzle 24 to the bottom of the aerosol can 22, a tube extends so that the inner end 24E thereof opens in the foamy solution. Further, the discharging nozzle 24 is connected to the tire valve by the flexible hose 26B.

Therefore, owing to the high pressure of vaporization of the liquefied gas, when a valve of the discharging nozzle 24 is opened, a mixed fluid of the foamy solution and the liquefied gas is discharged from the discharging nozzle 24 while foaming the solution. Accordingly, the foamed solution is led into the tire hollow.

### Comparison Test

The following liquid dampers (A), (B) and (C) were injected into a tire hollow formed by a 195/65R15 radial tire shown in FIG. 1 and a 15X6JJ wheel rim. Then, impact hammer test was conducted as follows.

Damper (A) was a water solution of a surfactant which was 25 weight % of sulfite triethanolamine and accordingly the water was 75% by weight. (V2/V1=19.3)

Damper (B) was an emulsion of elastomer which was SBR latex. The total solid of the emulsion was 60 parts by weight.

Damper (c) was water.

### Impact Hammer Test

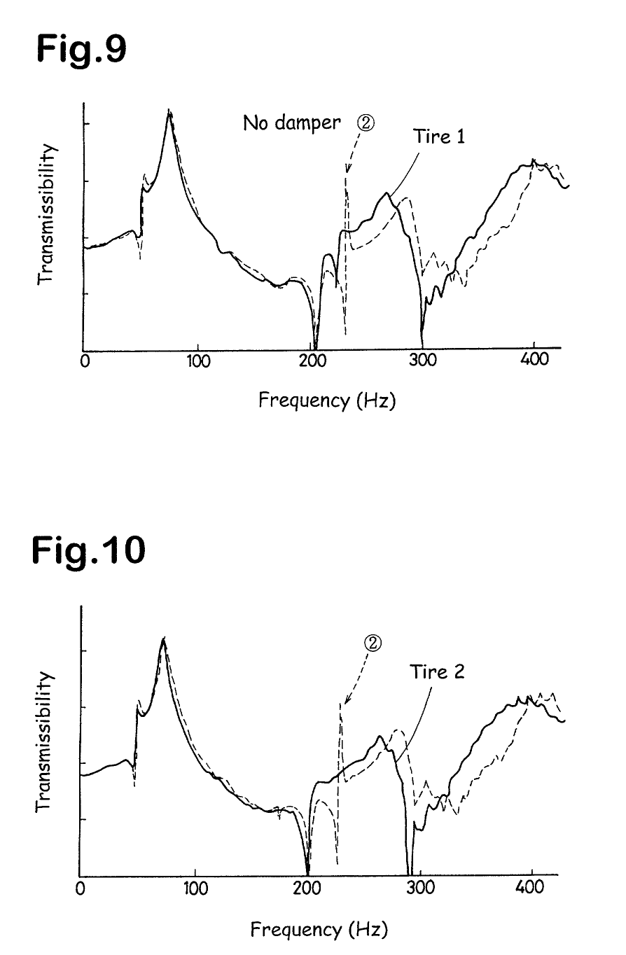

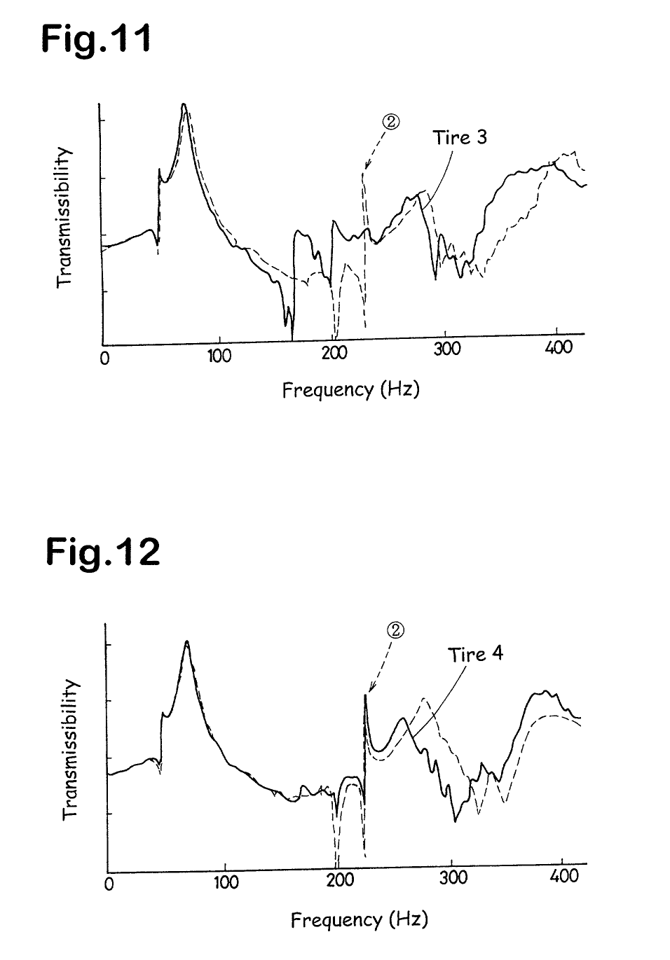

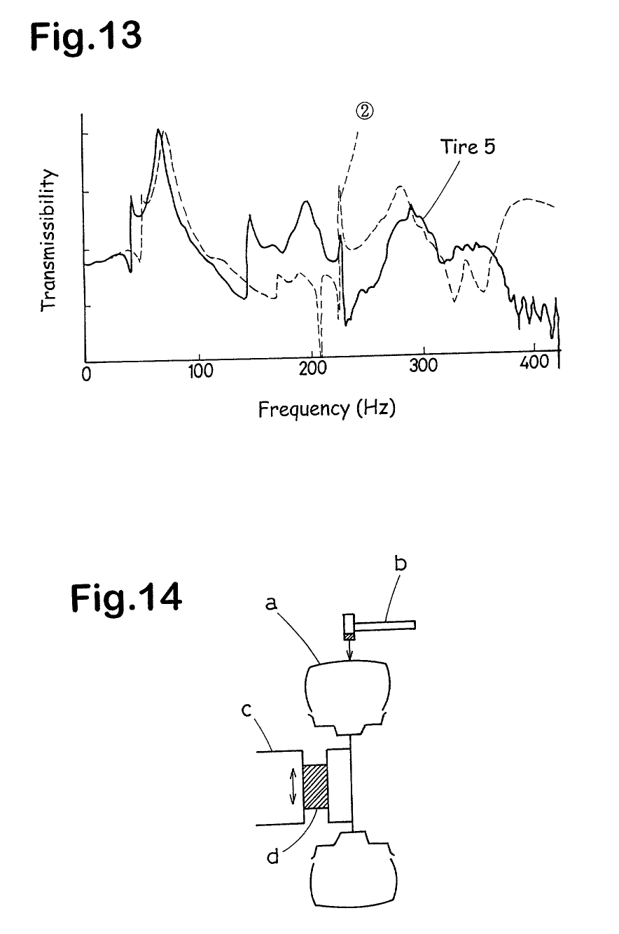

In order to obtain vibration transfer functions of the tire before and after the damper was injected, as shown in FIG. 15, vibrations when the tread portion was hit by a hammer were measured at the wheel axis, using a three-axis piezo-electric pickup, and analyzed by computer to plot vibration transfer functions. The obtained transfer functions are shown in FIGS. 9 to 13, wherein the vibration transfer functions before and after the damper was injected are plotted by a dotted line and a solid line, respectively. A peak \mathring{2} corresponds to the fundamental harmonic of the tire hollow.

In the test tire 2, the inflation of the tire and the injection of the damper were made at the same time using the injecting apparatus shown in FIG. 6. The others were inflated after the damper was injected. In either case, the inner pressure was adjusted to 200 kPa.

TABLE 1

| Tire | 1 | 2 | 3 | 4 | 5 |
|---|---|---|---|---|---|
| Damper | A | A | B | C | C |
| Injected weight (g) | 500 | 500 | 1000 | 500 | 15000 |
| Injected volume (cm3) | 5000 | 10000 | 1000 | 500 | 15000 |
| V/VO | 0.17 | 0.34 | 0.04 | 0.02 | 0.625 |
| Vibration transfer | | | | | |
| function | | | | | |

1. A tire noise reducing system comprising
a wheel rim,
a pneumatic tire to be mounted on the wheel rim to form an annular tire hollow, and
a noise damper to be disposed in the annular tire hollow, wherein
the noise damper is a liquid under use conditions, and the noise damper has a certain volume being capable of changing the cross sectional area of the annular tire hollow irregularly in the circumferential direction during rotating.

2. The tire noise reducing system according to claim 1, wherein
the liquid noise damper is an emulsion of at least one kind of polymer.

3. The tire noise reducing system according to claim 2, wherein
said at least one kind of polymer is at least one kind of elastomer.

4. The tire noise reducing system according to claim 2, wherein
said at least one kind of polymer is at least one kind of synthetic resin.

5. The tire noise reducing system according to claim 2, wherein
said at least one kind of polymer is at least one kind of elastomer and at least one kind of synthetic resin.

6. The tire noise reducing system according to claim 1, wherein
the liquid noise damper is a foamable emulsion of at least one kind of polymer.

7. The tire noise reducing system according to claim 1, wherein
the liquid noise damper is a foamable water solution of at least one kind of surfactant.

8. The tire noise reducing system according to claim 7, wherein
the liquid noise damper includes a foam stabilizer.

9. The tire noise reducing system according claim 6, 7 or 8, which further comprises an apparatus for injecting the foamable liquid damper into the tire hollow, the apparatus comprises
a container for the foamable liquid damper,
a high-pressure gas source to let the foamable liquid damper from the container, and
a nozzle for discharging a mixture of the liquid damper and high-pressure gas to be injected into the tire hollow.

10. The tire noise reducing system according claim 9, wherein said apparatus comprises
a passageway for high-pressure gas which extends from the high-pressure gas source to the container and is opened in the lower part of the inside of the container so as to open in the foamable liquid damper, and
a passageway for said mixture of the liquid damper and high-pressure gas which extends from the discharging nozzle into the inside of the container so as to open above the liquid level of the foamable liquid damper.

11. The tire noise reducing system according claim 9, wherein said apparatus comprises
a spray chamber, in which a spray nozzle and a gas nozzle are disposed, and to which said discharging nozzle is opened,
a passageway for the liquid damper which extends from the spray nozzle into the inside of the container and is opened in the lower part of the container so as to open in the foamable liquid damper, and
said gas nozzle connected to the high-pressure gas source and opened so as to blow high-pressure air against the spray nozzle.

12. The tire noise reducing system according claim 9, wherein
said high-pressure gas source is a liquefied gas
said container contains the liquid damper and said liquefied gas,
said apparatus comprises a passageway for a mixture of the liquid damper and liquefied gas which extends from said discharging nozzle into the inside of the container and is opened in the lower part of the container.
